(19) United States
(12) Patent Application Publication
(10) Pub. No.: US 2005/0240928 A1
(43) Pub. Date: Oct. 27, 2005

(54) Resource reservation

(76) Inventors: Theresa Mary Brown, Tucson, AZ (US); Thomas Charles Jarvis, Tucson, AZ (US); Shachar Fienblit, Ein Ayala (IL); Michael E. Factor, Haifa (IL)

Correspondence Address: KONRAD RAYNES & VICTOR, LLP.;ATTN: IBM37, 315 SOUTH BEVERLY DRIVE, SUITE 210, BEVERLY HILLS, CA, 90212, US

(21) Appl. No.: 10/822,061

(22) Filed: Apr. 9, 2004

(51) Int. Cl. G06F 9/46

(52) U.S. Cl. 718/100

(57) ABSTRACT

Provided is a technique for allocating resources. Reserved resources are allocated to one or more depth levels, wherein the reserved resources form one or more reserved pools. Upon receiving a request for allocation of resources, a depth level from which to allocate resources is determined. A reserved pool is allocated from the determined depth level.

### BACKGROUND

1. Field

Implementations of the invention relate to a resource reservation mechanism for deadlock prevention on distributed systems.

2. Description of the Related Art

Computing systems often include one or more host computers (“hosts”) for processing data and running application programs, direct access storage devices (DASDs) for storing data, and a storage controller for controlling the transfer of data between the hosts and the DASD. Storage controllers, also referred to as control units or storage directors, manage access to a storage space comprised of numerous hard disk drives connected in a loop architecture, otherwise referred to as a Direct Access Storage Device (DASD). Hosts may communicate Input/Output (I/O) requests to the storage space through the storage controller.

In many systems, data on one storage device, such as a DASD, may be copied to the same or another storage device so that access to data volumes can be provided from two different devices. A point-in-time copy involves physically copying all the data from source volumes to target volumes so that the target volume has a copy of the data as of a point-in-time. A point-in-time copy can also be made by logically making a copy of the data and then only copying data over when necessary, in effect deferring the physical copying. This logical copy operation is performed to minimize the time during which the target and source volumes are inaccessible.

One such logical copy operation is known as FlashCopy®. FlashCopy® involves establishing a logical point-in-time relationship between source and target volumes on different devices. The FlashCopy® function guarantees that until a track in a FlashCopy® relationship has been hardened to its location on the target disk, the track resides on the source disk. A relationship table is used to maintain information on all existing FlashCopy® relations in the subsystem. During the establish phase of a FlashCopy® relationship, one entry is recorded in the source and target relationship tables for the source and target that participate in the FlashCopy® being established. Each added entry maintains all the required information concerning the FlashCopy® relation. Both entries for the relationship are removed from the relationship tables when all FlashCopy® tracks from the source extent have been copied to the target extents or when a withdraw command is received.

Further details of the FlashCopy® operations are described in the copending and commonly assigned U.S. patent application Ser. No. 09/347,344, filed on Jul. 2, 1999, entitled “Method, System, and Program for Maintaining Electronic Data as of a Point-in-Time”; U.S. patent application Ser. No. 10/463,968, filed on Jun. 17, 2003, entitled “Method, System, And Program For Managing A Relationship Between One Target Volume And One Source Volume”; and U.S. patent application Ser. No. 10/463,997 filed on Jun. 17, 2003, entitled “Method, System, And Program For Managing Information On Relationships Between Target Volumes And Source Volumes When Performing Adding, Withdrawing, And Disaster Recovery Operations For The Relationships”, which patent applications are incorporated herein by reference in their entirety.

Once the logical relationship is established, hosts may then have immediate access to data on the source and target volumes, and the data may be copied as part of a background operation. A read to a track that is a target in a FlashCopy® relationship and not in cache triggers a stage intercept, which causes the source track corresponding to the requested target track to be staged to the target cache when the source track has not yet been copied over and before access is provided to the track from the target cache. This ensures that the target has the copy from the source that existed at the point-in-time of the FlashCopy® operation. Further, any writes to tracks on the source device that have not been copied over triggers a destage intercept, which causes the tracks on the source device to be copied to the target device.

A storage controller may be viewed as having multiple clusters, with each cluster being able to execute processes, access data, etc. When a point-in-time copy is across clusters, there are situations in which depletion of resources can cause a deadlock situation. For example, a deadlock may occur when a FlashCopy® operation is holding a resource on one cluster (e.g., cluster0) and needs to go to another cluster (e.g., cluster1) to complete the FlashCopy® operation, while another FlashCopy® operation on cluster1 may be throttled due to resources being depleted. In particular, if there is a different FlashCopy® operation that began on cluster1 holding resources and needs to go across to cluster0 to complete the FlashCopy® operation, there is a deadlock situation. That is, each FlashCopy® operation is holding some resources that the other FlashCopy® operation needs to complete.

As another example, Task Control Blocks (TCBs) are a type of resource. At time T1, there may be a request for a first point-in-time copy from a Source disk to a Target1 disk. At time T2, there may be modification of data in a Source cache that will later be destaged to Source disk. At time T3, there may be a request for a second point-in-time copy for a Target2 disk (i.e., a different target disk).

The second point-in-time copy operation needs the modifications made at time T2 to be destaged to disk. The Source, however, recognizes that the first point-in-time copy must complete and transfer data from the Source disk to the Target1 disk before the modifications are destaged. The Source tells Target1 to copy data. In order for Target1 to copy data, Target1 needs to obtain a certain number of TCBs. If Target2 has already obtained the last available TCBs, then Target1 cannot complete the first point-in-time copy operation. In this case, Target2, which is waiting on the first point-in-time copy operation to complete, is unable to complete. A deadlock situation results.

Therefore, there is a continued need in the art to avoid deadlock situations.

### SUMMARY OF THE INVENTION

Provided are an article of manufacture, system, and method for allocating resources. Reserved resources are allocated to one or more depth levels, wherein the reserved resources form one or more reserved pools. Upon receiving a request for allocation of resources, a depth level from which to allocate resources is determined. A reserved pool is allocated from the determined depth level.

### BRIEF DESCRIPTION OF THE DRAWINGS

Referring now to the drawings in which like reference numbers represent corresponding parts throughout:

FIG. 1 illustrates a computing environment in accordance with certain implementations.

FIGS. 2A and 2B illustrate logic for initialization performed by a resource manager in accordance with certain implementations.

FIGS. 3A, 3B, and 3C illustrate depth pools in accordance with certain implementations.

FIG. 4 illustrates logic for processing a request from a super process in accordance with certain implementations.

FIGS. 5A and 5B illustrate logic when a request for processing is received in accordance with certain implementations.

FIGS. 6A and 6B illustrate logic for completion of task control block processing in accordance with certain implementations.

FIG. 7 illustrates a flow of processing between two clusters in accordance with certain implementations.

FIG. 8 illustrates an example of processing between two clusters in accordance with certain implementations.

FIG. 9 illustrates an architecture of a computer system that may be used in accordance with certain implementations of the invention.

### DETAILED DESCRIPTION OF THE IMPLEMENTATIONS

In the following description, reference is made to the accompanying drawings which form a part hereof and which illustrate several implementations of the invention. It is understood that other implementations may be utilized and structural and operational changes may be made without departing from the scope of implementations of the invention.

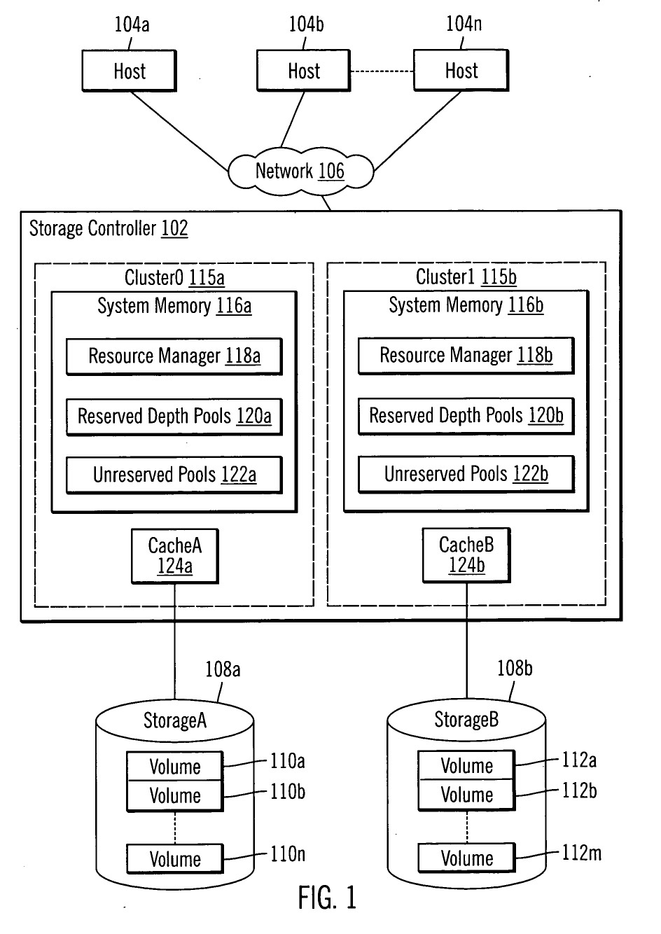

FIG. 1 illustrates a computing architecture in accordance with certain implementations. A storage controller 102 receives Input/Output (I/O) requests from host systems 104a, 104b . . . 104n over a network 106 directed toward storage devices 108a, 108b configured to have volumes (e.g., Logical Unit Numbers, Logical Devices, etc.) 110a, 110b . . . 110n and 112a, 112b . . . 112m, respectively, where m and n may be different positive integer values or the same positive integer value.

The storage controller 102 may be viewed as including two clusters, cluster0 115a and cluster1 115b. Although only two clusters are shown, any number of clusters may be included in storage controller 102. Cluster0 includes system memory 116a, which may be implemented in volatile and/or non-volatile devices. A resource manager 118a executes in the system memory 116a to manage the copying of data between the different storage devices 108a, 108b, such as the type of logical copying that occurs during a FlashCopy® operation. The resource manager 118a may perform operations in addition to the copying operations described herein. The resource manager 118a maintains reserved depth pools 120a in the system memory 116, from which resources (e.g., TCBs) may be allocated. Additionally, the resource manager 118a maintains unreserved pools 122a in the system memory, from which resources (e.g., TCBs) may be allocated. Cluster0 115a further includes cacheA 124a to store data (e.g., for tracks) in storageA 108a.

Cluster1 includes system memory 116b, which may be implemented in volatile and/or non-volatile devices. A resource manager 118b executes in the system memory 116b to manage the copying of data between the different storage devices 108a, 108b, such as the type of logical copying that occurs during a FlashCopy® operation. The resource manager 118b may perform operations in addition to the copying operations described herein. The resource manager 118b maintains reserved depth pools 120b in the system memory 116b, from which resources (e.g., TCBs) may be allocated. Additionally, the resource manager 118b maintains unreserved pools 122b in the system memory, from which resources (e.g., TCBs) may be allocated. Cluster1 115b further cacheB 124b to store data (e.g., for tracks) in storageB 108b.

The caches 124a, 124b may comprise separate memory devices or different sections of a same memory device. The caches 124a, 124b are used to buffer read and write data being transmitted between the hosts 104a, 104b . . . 104n and the storages 108a, 108b. Further, either one of caches 124a and 124b may be referred to as a source or target cache for holding source or target data in a copy relationship, the caches 124a and 124b may store at the same time source and target data in different copy relationships. The system memory 116a may be in a separate memory device from caches 124a and/or 124b or a part thereof.

The storage controller 102 further includes a processor complex (not shown) and may comprise any storage controller or server known in the art, such as the IBM Enterprise Storage Server (ESS)®, 3990® Storage Controller, etc. The hosts 104a, 104b . . . 104n may comprise any computing device known in the art, such as a server, mainframe, workstation, personal computer, hand held computer, laptop, telephony device, network appliance, etc. The storage controller 102 and host system(s) 104a, 104b . . . 104n communicate via a network 106, which may comprise a Storage Area Network (SAN), Local Area Network (LAN), Intranet, the Internet, Wide Area Network (WAN), etc. The storage systems 108a, 108b may comprise an array of storage devices, such as a Just a Bunch of Disks (JBOD), Redundant Array of Independent Disks (RAID) array, virtualization device, etc.

In certain implementations, to resolve resource contention, a resource manager 118 manages reserved resources (e.g., TCBs) for certain operations, such as FlashCopy® operations. The resource manager 118 allocates and reserves resources used by copy operations to ensure that an operation will complete, while avoiding deadlock situations.

In certain implementations, the resource manager 118 ensures that a process has enough resources on two or more clusters 115a, 115b of a storage controller 102 to complete an operation. In particular, the resource manager 118 reserves (i.e., sets aside) pools (i.e., groups) of resources that may be allocated to processes. For example, each task of a copy process may be associated with a “depth level”, and each depth level may be associated with a pool of resources. In certain implementations, depth level1 is associated with a staging of data at a target (e.g., Target2), depth level2 is associated with destaging of source cache to source disk, and depth level3 is associated with staging and destaging at a-different target (e.g., Target1). Then, if Target2 requests resources for staging data, the resources are taken from the depth level1 pool. If Target1 requests resources, the resources are taken from the depth level3 pool. Because each target obtains resources from different pools, deadlock situations are avoided.

To accomplish this, each process that is initiated on a local cluster is allocated enough resources on the local cluster to complete an operation, and each process that is activated by an opposite (“non-local” or “remote”) cluster is allocated enough resources to complete another operation.

Although implementations of the invention are applicable to any type of resource, examples herein will refer to TCBs, but this reference is for ease of understanding the invention and is not meant to limit implementations to TCBs. To avoid deadlock situations that may occur when the local cluster calls to an opposite cluster and the opposite cluster calls back to the local cluster, pre-allocated reserved TCBs that are reserved for such calls between clusters are allocated to processes. In certain implementations, during a super process execution, the current reserved TCBs depth level of the inter cluster call is determined, and TCBs reserved for this depth level are allocated. A “super” process may be described as a process in one cluster that requires sub-processes obtaining resources on other clusters to accomplish its processing, but which is itself is not a sub-process.

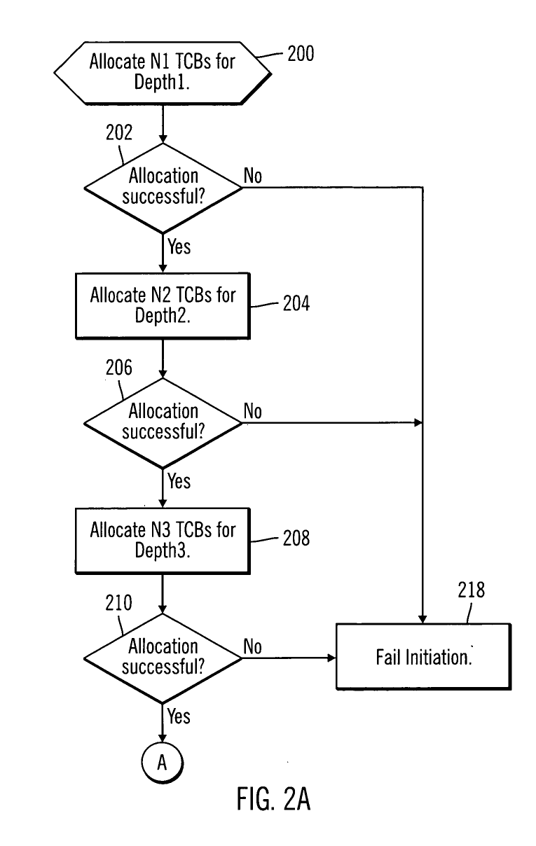

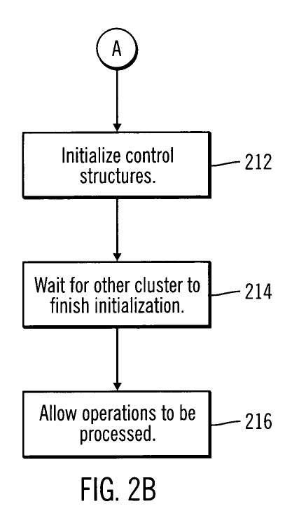

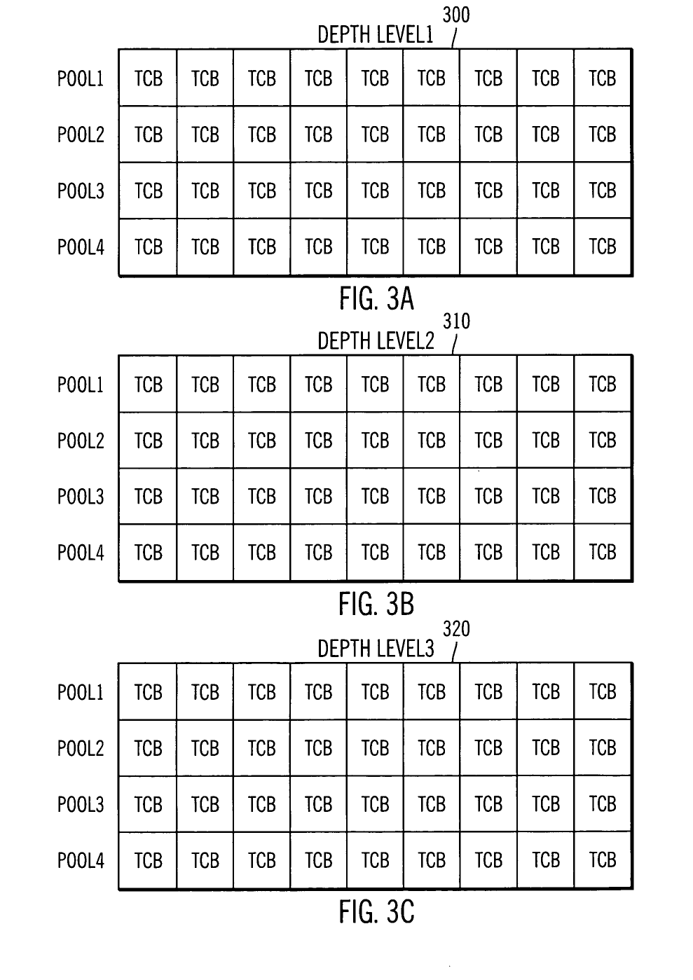

FIGS. 2A and 2B illustrate logic for initialization performed by the resource manager 118a, 118b in accordance with certain implementations. Control begins at block 200 with a number (N1, which may be any positive integer number and represents a number of columns times a number of rows, as illustrated in FIG. 3A) of TCBs being allocated for depth level1. In block 202, the resource manager 118a, 118b determines whether the allocation was successful. If so, processing continues to block 204, otherwise, processing continues to block 218.

In block 204, the resource manager 118a, 118b allocates a number (N2, which may be any positive integer number and represents a number of columns times a number of rows, as illustrated in FIG. 3B) of TCBs being allocated for depth level2. In block 206, the resource manager 118a, 118b determines whether the allocation was successful. If so, processing continues to block 208, otherwise, processing continues to block 218.

In block 208, the resource manager 118a, 118b allocates a number (N3, which may be any positive integer number and represents a number of columns times a number of rows, as illustrated in FIG. 3C) of TCBs being allocated for a depth level3. In block 210, the resource manager 118a, 118b determines whether the allocation was successful. If so, processing continues to block 212, otherwise, processing continues to block 218.

In block 212, the resource manager 118a, 118b initializes control structures during an initialization process. Control structures include, for example, structures that identify which TCBs have been allocated to which processes. In block 214, the resource manager 118a, 118b waits for the other cluster to finish the initialization process. In certain implementations, when one resource manager 118a, 118b finishes the initialization process, the resource manager 118a, 118b sends a message to the other resource manager 118a, 118b. In block 216, the resource manager 118a, 118b allows operations to be processed.

In block 218, if TCBs have not been allocated for depth level1, depth level2, or depth level3, the initialization is failed. In this case, there may not be available resources for an allocation or the pool size may be too large, and allocation may be reattempted at a later time (e.g., allocation may be attempted with a smaller pool size). In FIGS. 2A and 2B, the TCBs allocated for each depth level (depth level1, depth level2, and depth level3) may be divided to form one or more pools.

FIGS. 3A, 3B, and 3C illustrate depth pools in accordance with certain implementations. For example, in FIG. 3A, pool1, pool2, pool3, and pool4 are available for depth level1 300, and N1 represents a number of TCBs allocated to depth level1 (e.g., a number of columns times a number of rows (N1=9×4=36)). Likewise, in FIGS. 3B and 3C, pool1, pool2, pool3, and pool4 are available for depth level2 310 and depth level3 320, respectively. For depth level2 310, N2 represents a number of TCBs allocated to depth level2 (e.g., a number of columns times a number of rows (N2=9×4=36)), and for depth level3 320, N3 represents a number of TCBs allocated to depth level3 (e.g., a number of columns times a number of rows (N3=9×4=36)). Although the pools have been illustrated as the same size for each pool and each depth level, in various implementations, the pools for a particular depth level (e.g., all pools for depth level1 are the same size) may be the same size, while the sizes of pools for different depth levels may vary (e.g., a depth level1 pool may be larger than a depth level2 pool). Depth pools 310, 320, and 330 are examples of reserved depth pools 120a, 120b.

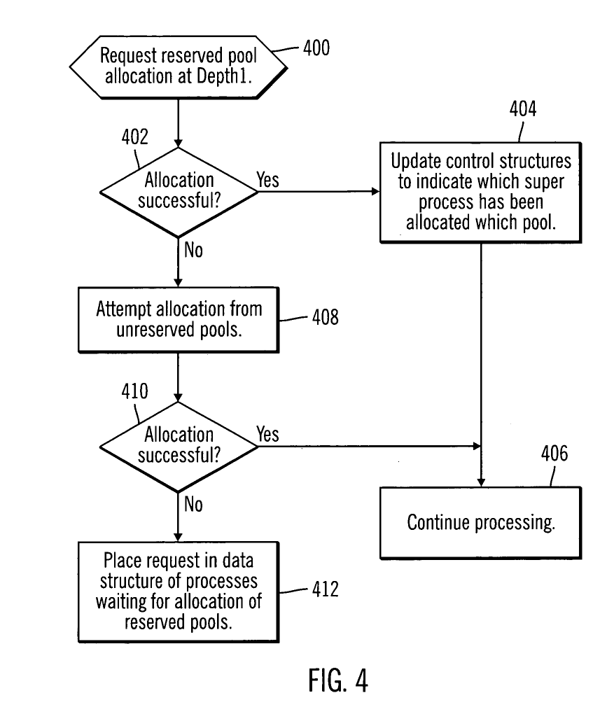

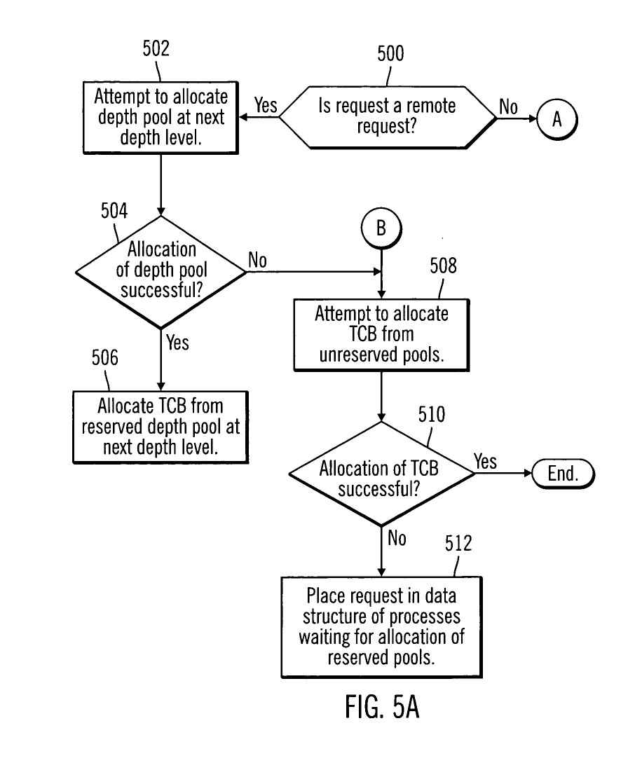

FIG. 4 illustrates logic for processing a request from a super process in accordance with certain implementations. For example, a super process may be requesting to establish a copy relationship, to stage data, or to destage data. Control begins at block 400 with the super process requesting a reserved pool allocation at depth level1. In certain implementations, an entire pool is allocated to a process until that process no longer needs the allocation. In block 402, the super process determines whether the allocation is successful. If so, processing continues to block 404, otherwise, processing continues to block 408. In block 404, the super process updates control structures to indicate which process has been allocated which pool of TCBs. In block 406, the super process continues processing.

If the allocation was unsuccessful (block 402), then in block 408, the super process attempts to allocate TCBs from unreserved pools. In block 410, the super process determines whether the allocation from unreserved pools was successful. If so, processing continues to block 406, otherwise, processing continues to block 412. In block 412, the super process places the request in a data structure (e.g., a queue) of processes waiting for allocation of reserved pools.

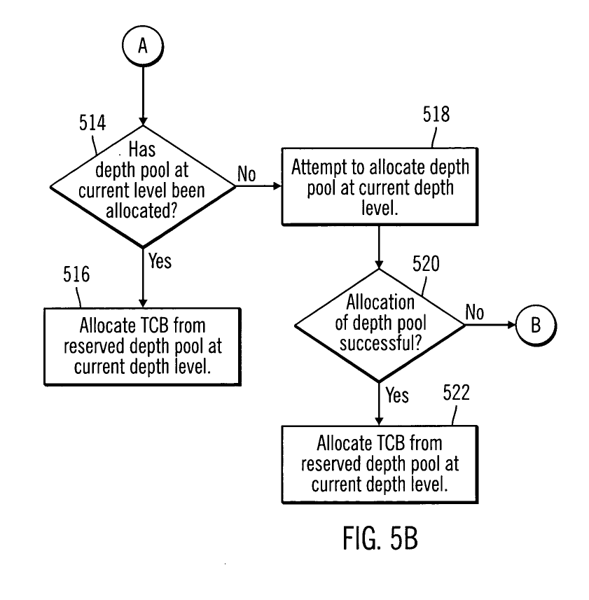

FIGS. 5A and 5B illustrate logic when a request for processing is received in accordance with certain implementations. Control begins at block 500 with a resource manager 118a, 118b determining whether a request for allocation of a TCB is a remote request. If so, processing continues to block 502, otherwise, processing continues to block 514 (FIG. 5B). In block 502, the resource manager 118a, 118b attempts to allocate a depth pool at the next depth level. For example, if currently, TCBs are being allocated from the depth level1 pool and the request is a remote request, then TCBs are allocated from the depth level2 pool. In block 504, the resource manager 118a, 118b determines whether the allocation of the depth pool was successful. If so, processing continues to block 506, otherwise, processing continues to block 508. In block 506, the resource manager 118a, 118b allocates a TCB from the reserved depth pool at the next depth level.

In block 508, the resource manager 118a, 118b attempts to allocate a TCB from one or more unreserved pools. In block 510, the resource manager 118a, 118b determines whether the allocation was successful. If so, processing ends, otherwise, processing continues to block 512. In block 512, the resource manager 118a, 118b places the request in a data structure (e.g., a queue) of processes waiting for allocation of reserved pools.

In block 514 (FIG. 5B), the resource manager 118a, 118b determines whether a depth pool at a current depth level has already been allocated to the process requesting the TCB. If so, processing continues to block 516, otherwise, processing continues to block 518. That is, if a depth pool has been allocated, then a TCB may be allocated from that depth pool. In block 516, the resource manager 118a, 118b allocates a TCB from the reserved depth pool at the current depth level. In block 518, the resource manager 118a, 118b attempts to allocate a depth pool at a current depth level. In block 520, the resource manager 118a, 118b determines whether the allocation of the depth pool was successful. If so, processing continues to block 522, otherwise, the processing continues to block 508 (FIG. 5A). In block 522, the resource manager 118a, 118b allocates a TCB from the reserved depth pool at the current depth level.

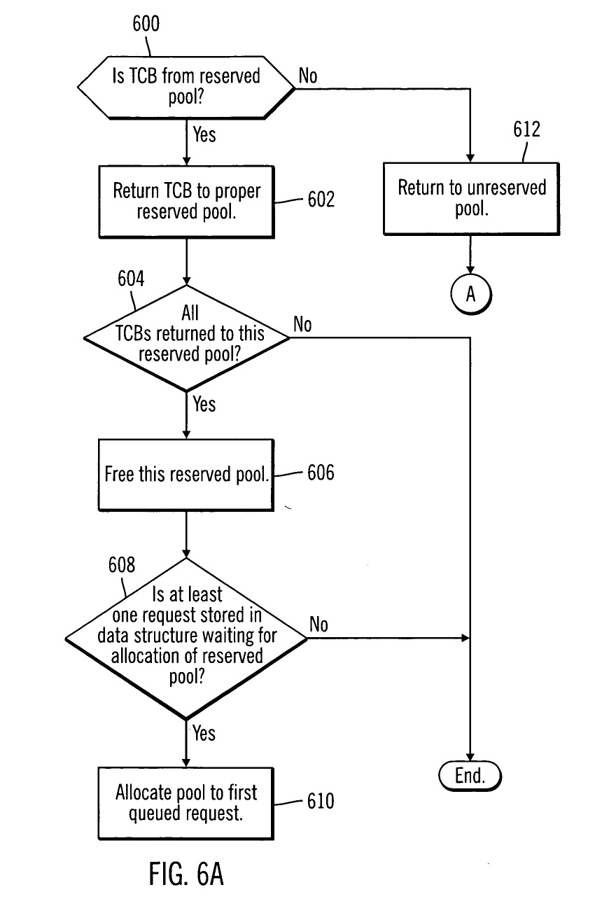

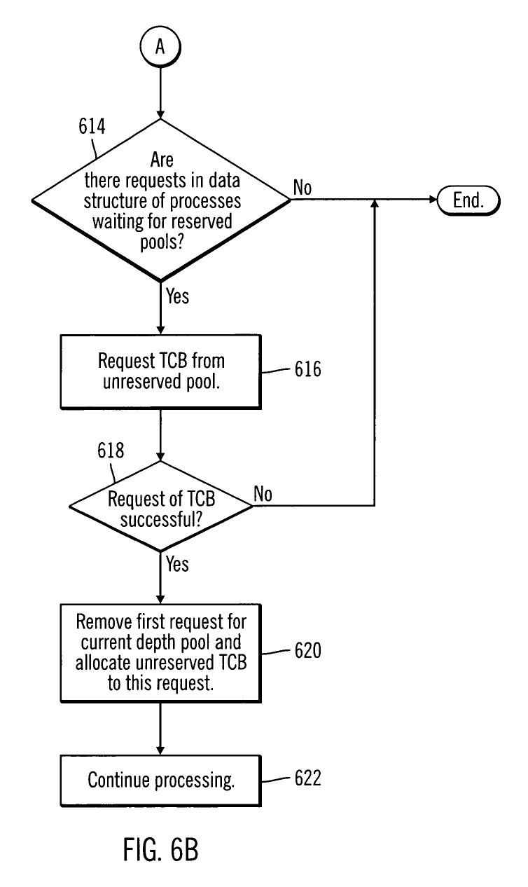

FIGS. 6A and 6B illustrates logic for completion of TCB processing in accordance with certain implementations. Control begins at block 600 with a resource manager 118a, 118b determining whether a TCB that has been returned by any process is from a reserved pool. If so, processing continues to block 602, otherwise, processing continues to block 612. In block 602, the resource manager 118a, 118b that determined that the TCT has been returned returns the TCB to the proper reserved pool. For example, the resource manager 118a, 118b may use the control structures to identify which reserved pool that TCB belongs to. In block 604, the resource manager 118a, 118b determines whether all TCBs have been returned to this reserved pool. If so, processing continues to block 606, otherwise, this processing ends. In block 606, the resource manager 118a, 118b frees the reserved pool so that it may be allocated to another process. In block 608, the resource manager 118a, 118b determines whether at least one request is stored in the data structure waiting for allocation of a reserved pool. If so, processing continues to block 610, otherwise, this processing ends. In block 610, the resource manager 118a, 118b allocates the freed reserved pool to the first stored request.

In block 612, the TCB is returned to an unreserved pool. In block 614 (FIG. 6B), the resource manager 118a, 118b determines whether there are requests in the data structure of processes waiting for reserved pools. If so, processing continues to block 616, otherwise, processing ends. In block 616, the resource manager 118a, 118b requests the TCB from the unreserved pool. In block 618, the resource manager 118a, 118b determines whether the request of the TCB was successful. If so, processing continues to block 620, otherwise, processing ends. In block 620, the resource manager 118a, 118b removes the first request for the current depth pool and allocates the unreserved TCB to the request. In block 622, the resource manager 118a, 118b continues processing.

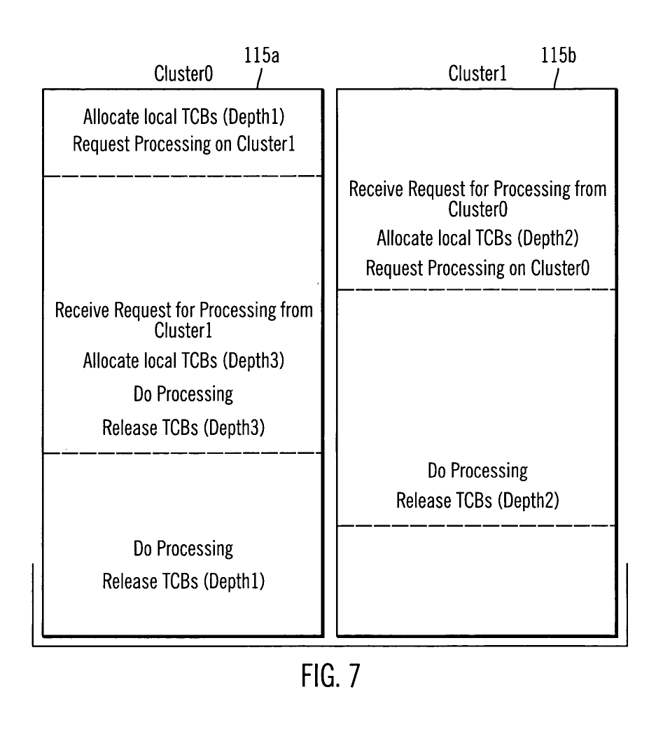

FIG. 7 illustrates a flow of processing between two clusters in accordance with certain implementations. The resource manager 118a at cluster0 115a allocates local TCBs from a depth level1 pool to a super process and requests processing on cluster1 115b. The resource manager 118b at cluster1 115b receives the request for processing from cluster0 115a, allocates local TCBs from a depth level2 pool for the super process, and requests processing on cluster0 for a sub-process. The resource manager 118a at cluster0 115a receives the request for processing from cluster1 115b, allocates local TCBs from a depth level3 pool to the sub-process, enables the sub-process to perform processing, and releases TCBs from the depth level3 pool. The resource manager 118b at cluster1 115b enables the super process to perform processing and releases TCBs from the depth level2 pool. Then, the resource manager 118a at cluster0 115a allows the super process to perform processing and releases TCBs from the depth level1 pool.

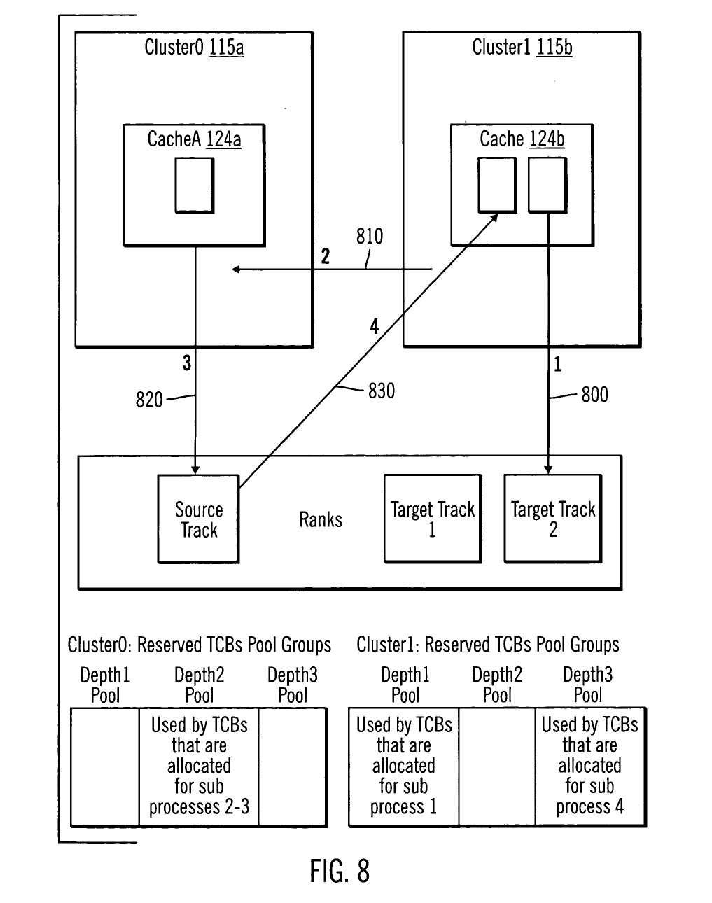

FIG. 8 illustrates an example of processing between two clusters in accordance with certain implementations. In FIG. 8, target track 1 and target track 2 are point in time copies of the same source track. Target track 1 is a copy of the source track at an earlier point in time than target track 2. In FIG. 8, there are three TCB pools, one for each depth level, for each cluster 115a, 115b. Arrow 800 represents that a partial track is to be destaged, but the track is a FlashCopy® operation target and before the destage can be done, a full track has to be staged. Arrow 810 represents that before the stage, data has to be moved from cache 124a to a source volume (i.e., a destage occurs). Arrow 820 represents that the data on the volume is to be destaged, but before this can be done, the volume's copy of the track has to be protected as it relates to target track1. Arrow 830 represents that the data on the volume's source track (target track 1) is to be moved into cache 124b.

When a process begins, it starts at depth level1. Each time the process goes across to the other cluster, the depth level is incremented. For example, in certain implementations, for a non-cascaded FlashCopy® operation, the maximum number of depths may be three.

As an example of the use of depth levels, in FIG. 8, a process is to destage a partial track on a target (depth level1). Before the destage can proceed, a stage of a full track to the target is to be completed. The stage intercept on the target may cause a destage on the source, which is on the opposite cluster (depth level2). The destage intercept on the source may need to protect the volume's image of the track on the device before the destage can proceed, so it calls back to the local cluster to force the data on the volume's targets (depth level3).

FlashCopy and Enterprise Storage Server are registered trademarks or common law marks of International Business Machines Corporation in the United States and/or other countries.

### Additional Implementation Details

The described embodiments may be implemented as a method, apparatus or article of manufacture using programming and/or engineering techniques to produce software, firmware, hardware, or any combination thereof. The term “article of manufacture” and “circuitry” as used herein refers to a state machine, code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. When the code or logic is executed by a processor, the circuitry may include the medium including the code or logic as well as the processor that executes the code loaded from the medium. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration, and that the article of manufacture may comprise any information bearing medium known in the art. Additionally, the devices, adapters, etc., may be implemented in one or more integrated circuits on the adapter or on the motherboard.

The logic of FIGS. 2A, 2B, 4, 5A, 5B, 6A, and 6B describes specific operations occurring in a particular order. In alternative implementations, certain of the logic operations may be performed in a different order, modified or removed. Moreover, operations may be added to the above described logic and still conform to the described implementations. Further, operations described herein may occur sequentially or certain operations may be processed in parallel, or operations described as performed by a single process may be performed by distributed processes.

The illustrated logic of FIGS. 2A, 2B, 4, 5A, 5B, 6A, and 6B may be implemented in software, hardware, programmable and non-programmable gate array logic or in some combination of software, hardware or gate array logic.

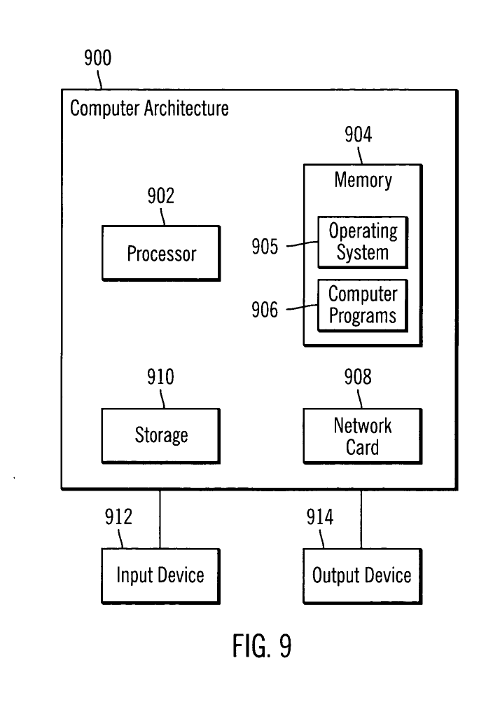

FIG. 9 illustrates an architecture 900 of a computer system that may be used in accordance with certain implementations of the invention. Hosts 104a, 104b . . . 104n and/or storage controller 102 may implement the computer architecture 900. The computer architecture 900 may implement a processor 902 (e.g., a microprocessor), a memory 904 (e.g., a volatile memory device), and storage 910 (e.g., a non-volatile storage area, such as magnetic disk drives, optical disk drives, a tape drive, etc.). An operating system 905 may execute in memory 904. The storage 910 may comprise an internal storage device or an attached or network accessible storage. Computer programs 906 in storage 910 may be loaded into the memory 904 and executed by the processor 902 in a manner known in the art. The architecture further includes a network card 908 to enable communication with a network. An input device 912 is used to provide user input to the processor 902, and may include a keyboard, mouse, pen-stylus, microphone, touch sensitive display screen, or any other activation or input mechanism known in the art. An output device 914 is capable of rendering information from the processor 902, or other component, such as a display monitor, printer, storage, etc. The computer architecture 900 of the computer systems may include fewer components than illustrated, additional components not illustrated herein, or some combination of the components illustrated and additional components.

The computer architecture 900 may comprise any computing device known in the art, such as a mainframe, server, personal computer, workstation, laptop, handheld computer, telephony device, network appliance, virtualization device, storage controller, etc. Any processor 902 and operating system 905 known in the art may be used.

The foregoing description of implementations of the invention has been presented for the purposes of illustration and description. It is not intended to be exhaustive or to limit the implementations of the invention to the precise form disclosed. Many modifications and variations are possible in light of the above teaching. It is intended that the scope of the implementations of the invention be limited not by this detailed description, but rather by the claims appended hereto. The above specification, examples and data provide a complete description of the manufacture and use of the composition of the implementations of the invention. Since many implementations of the invention can be made without departing from the spirit and scope of the implementations of the invention, the implementations of the invention reside in the claims hereinafter appended or any subsequently-filed claims, and their equivalents.

1. A method for allocating resources, comprising:
allocating reserved resources to one or more depth levels, wherein the reserved resources form one or more reserved pools;
upon receiving a request for allocation of resources, determining a depth level from which to allocate resources; and
allocating a reserved pool from the determined depth level.

2. The method of claim 1, further comprising:
generating control structures that indicate which resources are allocated to which processes.

3. The method of claim 1, wherein the allocations occur at a first cluster and further comprising:
at the first cluster, waiting for a second cluster to finish initialization processing before allowing requests for resources to be processed at the first cluster.

4. The method of claim 1, further comprising:
when the allocation of the reserved pool is unsuccessful, attempting to allocate resources from an unreserved pool.

5. The method of claim 4, further comprising:
when the allocation from the unreserved pool is unsuccessful, placing the request in a data structure to wait for a reserved pool.

6. The method of claim 1, wherein the resources are task control blocks.

7. The method of claim 1, further comprising:
determining that a reserved pool at the determined depth level has been allocated; and
allocating a resource from the reserved pool.

8. The method of claim 7, wherein when the request is a remote request, the determined depth level is a next depth level.

9. The method of claim 7, wherein when the request is a local request, the depth level is a current depth level.

10. The method of claim 7, further comprising:
determining that processing with the resource is complete; and
returning the resource to a pool of resources.

11. The method of claim 10, further comprising:
when the resource is returned to a reserved pool, determining whether all resources have been returned to that reserved pool;
when all resources have been returned, freeing the reserved pool for allocation to another process; and
allocating the freed reserved pool to a request waiting for allocation of a reserved pool.

12. The method of claim 10, further comprising:
when the resource is returned to an unreserved pool, allocating the freed unreserved pool to a request waiting for allocation of a reserved pool at a current depth level.

13. An article of manufacture including program logic for allocating resources, wherein the program logic is capable of causing operations to be performed, the operations comprising:
allocating reserved resources to one or more depth levels, wherein the reserved resources form one or more reserved pools;
upon receiving a request for allocation of resources, determining a depth level from which to allocate resources; and
allocating a reserved pool from the determined depth level.

14. The article of manufacture of claim 13, wherein the operations further comprise:
generating control structures that indicate which resources are allocated to which processes.

15. The article of manufacture of claim 13, wherein the allocations occur at a first cluster and wherein the operations further comprise:
at the first cluster, waiting for a second cluster to finish initialization processing before allowing requests for resources to be processed at the first cluster.

16. The article of manufacture of claim 13, wherein the operations further comprise:
when the allocation of the reserved pool is unsuccessful, attempting to allocate resources from an unreserved pool.

17. The article of manufacture of claim 16, wherein the operations further comprise:
when the allocation from the unreserved pool is unsuccessful, placing the request in a data structure to wait for a reserved pool.

18. The article of manufacture of claim 13, wherein the resources are task control blocks.

19. The article of manufacture of claim 13, wherein the operations further comprise:
determining that a reserved pool at the determined depth level has been allocated; and
allocating a resource from the allocated reserved pool.

20. The article of manufacture of claim 19, wherein when the request is a remote request, the determined depth level is a next depth level.

21. The article of manufacture of claim 19, wherein when the request is a local request, the determined depth level is a current depth level.

22. The article of manufacture of claim 19, wherein the operations further comprise:
determining that processing with the resource is complete; and
returning the resource to a pool of resources.

23. The article of manufacture of claim 22, wherein the operations further comprise:
when the resource is returned to a reserved pool, determining whether all resources have been returned to that reserved pool;
when all resources have been returned, freeing the reserved pool for allocation to another process; and
allocating the freed reserved pool to a request waiting for allocation of a reserved pool.

24. The article of manufacture of claim 22, wherein the operations further comprise:
when the resource is returned to an unreserved pool, allocating the freed unreserved pool to a request waiting for allocation of a reserved pool at a current depth level.

25. A system including circuitry for allocating resources, wherein the circuitry is capable of causing operations to be performed, the operations comprising:
allocating reserved resources to one or more depth levels, wherein the reserved resources form one or more reserved pools;
upon receiving a request for allocation of resources, determining a depth level from which to allocate resources; and
allocating a reserved pool from the determined depth level.

26. The system of claim 25, wherein the operations further comprise:
generating control structures that indicate which resources are allocated to which processes.

27. The system of claim 25, wherein the operations further comprise:
when the allocation of the reserved pool is unsuccessful, attempting to allocate resources from an unreserved pool.

28. The system of claim 27, wherein the operations further comprise:
when the allocation from the unreserved pool is unsuccessful, placing the request in a data structure to wait for a reserved pool.

29. The system of claim 25, wherein the operations further comprise:
determining that a reserved pool at the determined depth level has been allocated; and
allocating a resource from the allocated reserved pool.

30. The system of claim 25, wherein when the request is a remote request, the determined depth level is a next depth level and when the request is a local request, the determined depth level is a current depth level.
